(19) United States
(12) Patent Application Publication
(10) Pub. No.: US 2026/0054965 A1
(43) Pub. Date: Feb. 26, 2026

(54) BEARING APPARATUS, PARTICULARLY RAIL BEARING FOR A CRANEWAY

(71) Applicant: RSE+ Beteiligungen GmbH, Kassel (DE)

(72) Inventors: Oliver Bleichert, Kassel (DE); Gerd Christian Wagner, Wolfhagen (DE)

(73) Assignee: RSE+ Beteiligungen GmbH, Kassel (DE)

(21) Appl. No.: 19/371,855

(22) Filed: Oct. 28, 2025

Related U.S. Application Data
(63) Continuation-in-part of application No. 19/190,068, filed on Apr. 25, 2025.

(30) Foreign Application Priority Data
Apr. 26, 2024 (DE) 10 2024 111 852.0

(51) Int. Cl. B66C 7/08

(52) U.S. Cl. CPC B66C 7/08

(57) ABSTRACT

A bearing apparatus has a mounting element for mounting a construction element of a steel construction, a base element to be fastened to a supporting structure and an adjustable compensation device for adjusting a height position and an angular position of the mounting element relative to the base element and supporting the mounting element at the base element in direction of a virtual main axis. The compensation device comprises a mechanical series connection of a lockable articulated joint arrangement and a supporting column. The unlocked articulated joint arrangement allows the mounting element to be pivoted relative to the base element about any pivot axis orthogonally intersecting the main axis. The supporting column has a length which is variable by screwing an inner column in an outer column of the supporting column. A screwed-in position of the supporting column is fixed by the construction element mounted to the mounting element.

### CROSS REFERENCE TO RELATED APPLICATIONS

This application is a continuation-in-part to U.S. patent application Ser. No. 19/190,068 filed on Apr. 25, 2025 and claiming priority to co-pending German Patent Application No. DE 10 2024 111 852.0 entitled “Schienenlager, insbesondere für eine Kranbahn” and filed Apr. 26, 2024, the entire disclosures of which are hereby incorporated herein by reference in their entirety.

### FIELD

The invention relates to a bearing apparatus comprising a mounting element for mounting a construction element of a steel construction, a base element for fastening to a supporting structure, and an adjustable compensation device orienting the mounting element with respect to the base element and supporting the mounting element at the base element in a virtual main axis of the bearing apparatus to be aligned vertically. With the aid of the compensation device, a height position and an angular position of the mounting element relative to the base element can be adjusted.

The adjustability of the compensation device of the bearing apparatus serves, for example, to compensate for deviations of the supporting structure from a desired course of a rail to be supported, so that the rail runs exactly horizontally, in a straight line and parallel to a second rail, for example.

The bearing apparatus can be designed for upright installation, in which the construction element of the steel construction extends above the supporting structure and stands on the supporting structure via the bearing apparatus. It is also possible to mount the bearing apparatus in a suspended installation, in which the construction element of the steel construction extends below the supporting structure and hangs from the supporting structure via the bearing apparatus.

A rail to be supported by the bearing apparatus can be directly a running rail of any profile for guiding rollers or wheels of any carriage. Alternatively, an additional intermediate rail can be arranged between such a running rail and the mounting element in order to prevent deflection of the running rail under heavy loads.

A plurality of the bearing apparatuses can be used to make a craneway with two rails, the bearing apparatuses being distributed along the two rails and aligning the two rails with respect to the supporting structure in a defined manner.

In other embodiments, the construction element to be supported by the bearing apparatus is a rail-shaped horizontal beam or any other construction element of a steel construction, which may in particular be the steel construction of a steel building, which is supported via a plurality of the bearing apparatuses on and oriented with respect to a supporting structure, for example of concrete, such as a concrete foundation.

### BACKGROUND

German Democratic Republic patent application publication DD 233 605 A1 describes a craneway support on reinforced concrete columns with console formation. The craneway support consists of two truss plates that are strapped around the reinforced concrete column via beams and lining plates using connecting elements. The truss plates each consist of a cantilever arm, vertical strut, sleeve, filler rod and diagonal strut between the cantilever arm and sleeve. The vertical brace is extended downwards for heavy cranes. The base of the extended vertical brace is fixed to the respective reinforced concrete column by a sleeve. At the same time, this base is connected to the cantilever arm below the craneway by diagonal braces. Larger holes in an upper support plate can be used to compensate for existing construction tolerances of the respective reinforced concrete support. After aligning the craneway, the upper support plate should be connected to a lower support plate by a fillet weld. Furthermore, height and lateral adjustability are realized by means of lining plates and elongated holes.

A craneway bearing is known from Soviet Union patent application publication SU 750001 A1, in which a craneway is set down on a lower console of a supporting structure and in which lateral forces are absorbed by an upper console of the supporting structure, which is located approximately at the height of a running rail of the craneway. For this purpose, length-adjustable spacer elements are provided which have components that are bolted together.

A craneway is known from Switzerland patent application publication CH 446 652 A, which comprises several similar track sections consisting of rail elements held at a distance from each other by spacers. At one end of the track sections, at least one height-adjustable support is provided for each rail element, which supports the track section on a base plate. The height-adjustable support is designed with threaded spindles. Two threaded nuts arranged symmetrically to the vertical longitudinal center plane of each rail element are permanently attached to each end. The threaded spindles supported at the base plate can be rotated in the threaded nuts. The height-adjustable supports are pivotably supported at the base plate transversely to the longitudinal direction of the track.

U.S. Pat. No. 1,572,856 A discloses a spreading device for widening a saw cut when felling trees, having closed, structured contact surfaces for abutment against delimiting surfaces of the respective saw cut. The spreading device comprises a cup-shaped outer column, which forms a hollow joint head with its bottom region, and a cup-shaped inner column which is screwed into the outer column. The outer column and the inner column can be unscrewed from each other for spreading the contact surfaces apart. The cup-shaped inner column forms, with its bottom region, one of the contact surfaces. A rear side of a joint housing, in which the hollow joint head is held by means of a bolt screwed into the joint housing, forms the other contact surface. The bolt has radial play with respect to the hollow joint head and may not be tightened, such that an angle between the contact surfaces is variable.

There still is a need of a bearing apparatus suitable, for example, as a craneway bearing, in which a height position and an angular position of a mounting element for supporting a construction element of a steel construction can be adjusted at least largely independently of one another with respect to a base element for fastening to a supporting structure.

### SUMMARY OF THE INVENTION

The present invention relates to a bearing apparatus. The bearing apparatus comprises a virtual main axis to be aligned vertically, a mounting element configured for mounting a construction element of a steel construction, a base element configured for being attached to a supporting structure, and an adjustable compensation device. The adjustable compensation device extends between the mounting element and the base element along the virtual main axis and is configured for orienting the mounting element with respect to the base element and for supporting the mounting element at the base element in direction of the virtual main axis. The compensation device comprises a mechanical series connection of an articulated joint arrangement which defines a pivot point located on the main axis and which can be locked and unlocked, and a supporting column comprising an inner column and an outer column and a length along the virtual main axis which can be varied by screwing the inner column in the outer column. The mechanical series connection extends along the main axis. The unlocked articulated joint arrangement allows the mounting element to pivot relative to the base element about any pivot axis which intersects the main axis at a right angle at the pivot point; and a screwed-in position of the inner column in the outer column of the supporting column is fixed by a construction element mounted to the mounting element. Thus, a height position and an angular position of the mounting element relative to the base element can be adjusted with the aid of the compensation device.

The present invention also relates to a rail bearing. The rail bearing comprises a virtual main axis to be aligned vertically, a mounting element configured for mounting a rail, a base element configured for being attached to a supporting structure, and an adjustable compensation device extending between the mounting element and the base element along the virtual main axis and configured for orienting the mounting element with respect to the base element and for supporting the mounting element at the base element in direction of the virtual main axis. The compensation device comprises a mechanical series connection of an articulated joint arrangement which defines a pivot point located on the main axis and which can be locked and unlocked, and a supporting column comprising an inner column and an outer column and a length along the virtual main axis which can be varied by screwing the inner column in the outer column. The mechanical series connection extends along the main axis. The unlocked articulated joint arrangement allows the mounting element to pivot relative to the base element about any pivot axis which intersects the main axis at a right angle at the pivot point. A screwed-in position of the inner column in the outer column of the supporting column is fixed by a rail mounted to the mounting element. A smallest column diameter of the supporting column transverse to the main axis is at least about 100% of a maximum column height of the supporting column along the main axis. The outer column is pot-shaped column and has an internal thread, and wherein the inner column has an external thread screwed into the internal thread. The external thread engages in the internal thread over at least 3 thread turns in each length of the supporting column; and the mounting element is supported at the base element exclusively via the mechanical series connection of the articulated joint arrangement and the supporting column.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows a first embodiment of the bearing apparatus according to the invention mounted to a supporting structure and supporting a rail as a rail bearing, in a section along a vertically aligned main axis of the bearing apparatus.

FIG. 2 is a top view of the embodiment of the bearing apparatus according to FIG. 1.

FIG. 3 is a perspective isometric view of the embodiment of the bearing apparatus according to FIGS. 1 and 2, without the supporting structure.

FIG. 4 shows a vertical sectional view similar to FIG. 1 of another embodiment of the bearing apparatus according to the invention.

FIG. 5 shows a perspective isometric view of the embodiment of the bearing apparatus according to FIG. 4.

FIG. 6 shows a vertical sectional view corresponding to FIG. 4 of the embodiment of the bearing apparatus according to FIGS. 4 and 5, after adjustment of a pivot angle of its articulated joint arrangement; and

FIG. 7 shows a perspective isometric view corresponding to FIG. 5 of the embodiment of the bearing apparatus according to FIGS. 4 to 6, after adjustment of the pivot angle according to FIG. 6.

### DETAILED DESCRIPTION

A bearing apparatus according to the present disclosure comprises a mounting element for mounting a construction element of a steel construction, a base element for fastening to a supporting structure, and an adjustable compensation device which orients the mounting element with respect to the base element and supports the mounting element at the base element in the direction of a virtual main axis of the bearing apparatus which is to be aligned vertically. The compensation device can be used to adjust the height and angular position of the mounting element relative to the base element. For this purpose, the compensation device has a mechanical series connection of an articulated joint arrangement and a supporting column, the mechanical series connection being oriented along the main axis. The articulated joint arrangement can be locked by interlocking its components; and the unlocked articulated joint arrangement allows the mounting element to pivot relative to the base element about any pivot axis that intersects the main axis at a right angle at a predetermined pivot point. The supporting column is variable in length along the main axis by screwing-in; and a screwed-in position of the supporting column is fixable by the construction element of the steel construction mounted to the mounting element, i.e. it is fixed by the construction element mounted to the mounting element.

As explained at the beginning, the bearing apparatus can be provided either for upright or suspended installation, so that the base element is located either below or above the mounting element and the construction element mounted to it in the direction of the virtual main axis of the bearing apparatus to be aligned vertically.

In order to adjust the height and angular position of the mounting element relative to the base element, the articulated joint arrangement and the supporting column are connected in series. By the unlocked articulated joint arrangement allowing the mounting element to pivot relative to the base element about any pivot axis that intersects the main axis to be aligned vertically at a right angle at the specified pivot point, the angular position of the mounting element relative to the base element can be adjusted in terms of its inclination relative to the horizontal. In particular, a construction element in the form of a rail mounted to the mounting element can be aligned exactly horizontally or with a predetermined inclination and exactly vertically or with a predetermined lateral tilt.

The remaining third degree of freedom of rotation, which in this example concerns the direction of the rail mounted to the mounting element, is less critical. In order to achieve adaptability of the bearing apparatus in this direction of rotation about the main axis, the unlocked articulated joint arrangement can additionally allow the mounting element to rotate relative to the base element about the main axis. As a rule, however, it is sufficient if the construction element can be attached to the mounting element in a discrete number of rotational positions about the main axis, which will be explained in more detail.

In any case, in the bearing apparatus according to the present disclosure, the screwed-in position of the supporting column is at least also fixed by the construction element mounted to the mounting element, assuming that the construction element or a further construction element rigidly connected to the mounting element is also mounted in further bearing apparatuses. These further bearing apparatuses may also be designed in accordance with the present disclosure or in another way. In principle, the screwed-in position of the supporting column can also be fixed by a counter element or locking element. It is also possible to secure the screwed-in position of the supporting column with a screw locking lacquer or similar. So that the screwed-in position of the supporting column can be fixed by the construction element mounted to the mounting element, the supporting column has only two components screwed together, i.e. a component on the mounting element side and a component on the base element side, whose relative rotational position about the main axis is fixed by fixing the base element to a supporting structure and fixing the construction element of the steel construction to the mounting element.

When assembling the bearing apparatus according to the present disclosure, the height position of the mounting element relative to the base element and the inclination of the mounting element relative to the base element are adjusted as required in any order but separately from one another. The inclination of the mounting element relative to the base element is then fixed by locking the articulated joint arrangement, and the height position of the mounting element relative to the base element is fixed by fixing the construction element in the resulting rotational position of the mounting element about the main axis.

The predetermined pivot point, at which the pivot axes made possible by the articulated joint arrangement intersect the main axis at right angles, may be located close to or beyond a construction connection face of the mounting element, i.e. at the base of the construction element mounted thereto. In one embodiment, the predetermined pivot point, in the direction along the main axis, has a distance from the construction connection face of the mounting element which is not more than 20% of a total height of the bearing apparatus along the main axis between a structure connection face of the base element and the construction connection face of the mounting element. The distance may even be not more than 10% of the total height. If the predetermined pivot point lies exactly in the construction connection face of the mounting element, the articulated joint arrangement can be used to adjust the inclination of the construction connection face without the construction connection face shifting in the direction radial to the main axis, i.e. without the need to subsequently compensate for such displacements. In another embodiment, the predetermined pivot point, in the direction along the main axis, has a distance from the construction connection face of the mounting element which is about 200% of a total height of the bearing apparatus along the main axis between a structure connection face of the base element and the construction connection face of the mounting element.

Specifically, the articulated joint arrangement may comprise a ball joint with a spherical shell section-shaped joint housing and a hollow joint head resting therein. The mobility of the joint head in the joint housing of the ball joint enables direct pivoting movements about all pivot axes running at right angles at the pivot point through the main axis. In addition, the third degree of freedom of rotation about the main axis is also realized due to the rotatability of the joint head in the spherical shell about the main axis.

If the spherical radius of the joint housing and the joint head is then relatively large, the pivot point can be specified particularly easily close to or beyond the construction connection face, even if the supporting column is located between the articulated joint arrangement and the mounting element in the mechanical series connection. Specifically, the joint head may have a spherical radius that is greater than an outer diameter of the inner column, or 1.5 to 2.5 times—for example, approximately twice—as large as the outer diameter of the inner column.

However, it is understood that if the variable-length supporting column is arranged in the mechanical series connection between the articulated joint arrangement and the mounting element, each time the length of the supporting column is changed, the pivot point along the main axis specified by the articulated joint arrangement is displaced relative to the mounting element and the construction connection face provided on the latter.

In order to achieve the largest possible contact surface of the joint head in the joint housing, the diameter of the joint head transverse to the main axis may be at least as large as the smallest column diameter of the supporting column; and, in an embodiment, the diameter of the joint head transverse to the main axis is equal to an outer diameter of the outer column or the inner column, which is formed integrally with the hollow joint head of the articulated joint arrangement. The forces acting on the bearing apparatus in the direction of the main axis are distributed over this large contact surface. The joint housing may be so large transverse to the main axis that the joint head is in full contact with the joint housing in all relative positions that are reached when adjusting the angular position of the mounting element in relation to the base element.

If the joint housing and/or the hollow joint head has an opening for the passage of a fastening bolt extending along the main axis, the fastening bolt having radial play in at least one of the openings, the joint head can be pivoted in the joint housing over this play, and the pivoted position achieved can be fixed by tightening the fastening bolt. The fastening bolt presses a clamping element having a spherical-segment-shaped underside, which rests on the edge of the opening, against the rear side of the hollow joint head. In an embodiment, only the joint housing or the hollow joint head has an opening, while an internal thread is provided in the joint housing, into which the fastening bolt is screwed to tighten the two components of the ball joint.

In an embodiment, the bottom region of the other one of the inner column and the outer column that is not formed integrally with the hollow joint head has a central opening for the passage of a tool for tightening the fastening bolt. Additionally or alternatively, the fastening bolt can be supported at one end of the clamping element having a small inner diameter and a small outer diameter, while the spherical-segment-shaped underside, which is supported on the rear side of the hollow joint head, is formed at the other end of the clamping element and has a large inner diameter and a large outer diameter. The large inner diameter is at least twice as large as the small inner diameter, and the large outer diameter is at least 1.5 times as large as the small outer diameter.

The tool for tightening the fastening bolt may be a socket wrench.

The large inner diameter may be 2.5 to 5 times, for example about three times, as large as the small inner diameter, and the large outer diameter may be 1.75 to 3 times, for example about twice, as large as the small outer diameter.

The supporting column of the bearing apparatus according to the present disclosure may have a rather small elongation in the direction of the main axis. The smallest column diameter of the supporting column transverse to the main axis may be at least 100% of a column height of the supporting column along the main axis. The column diameter may be at least 125% or even at least 150% of the column height. The foregoing statements at least relate to the supporting column in its maximally screwed-together state. Due to the compact shape of the supporting column, the shape of the supporting column is buckling-resistant. In addition, the areas of the components of the supporting column that are screwed into each other and support each other in the direction of the main axis are comparatively large, as they extend over a large circumference around the main axis. The forces acting in the direction of the main axis are therefore also supported over large areas in the area of the supporting column. It is understood that the size of these surfaces also depends on the shape of the threads of the components of the supporting column that engage each other when screwed-in. Accordingly, it is understood that thread shapes that provide particularly large support surfaces, such as flat threads, may be selected. However, standard metric threads (M-threads) are also well suited.

A pitch of the external thread may amount to 1% to 4% of a diameter of the external thread, and the diameter of the external thread may be 100 mm to 200 mm. Specifically, the thread may be approximately an M 150×2 thread. For any M . . . ×2 thread, each relative rotation of 45° results in a change in length of the supporting column by 0.25 mm.

Specifically, the supporting column can have a pot-shaped outer column with an internal thread and an inner column with an external thread that can be screwed into the internal thread, wherein the inner column may vice versa be pot-shaped. In order to always ensure large mutual supporting surfaces of the threads, the external thread may should engage in the internal thread over at least three thread turns in each functional position of the supporting column. An engagement over at least five or even over at least ten thread turns in each functional position of the supporting column will further increase the mutual supporting surfaces of the threads. The design of the outer column and the inner column can ensure that the external thread always engages with the internal thread over the same number of thread turns in every functional position of the supporting column. However, it is sufficient that the minimum number of threads engage even if the supporting column is at its maximum length, i.e. even if the inner column is only minimally screwed into the outer column.

The outer column or the inner column can be formed in one piece with a component of the articulated joint arrangement. This applies in particular to the inner column. Thus, a bottom region of the inner column, which is also pot-shaped, merges into the component of the articulated joint arrangement or forms it directly. For example, the bottom region of the inner column can form the hollow joint head of the ball joint, and the other bottom region extending transversely to the main axis and having the central opening for the passage of the tool can be the bottom region of the outer column. In this case, the inner column may have, at its end opposite the hollow joint head, an inwardly directed reinforcing flange.

Conversely, a base area of the inner column or outer column extending transversely to the main axis can form the mounting element and be provided with at least eight fixation holes arranged in a ring around the main axis. The fixation holes may be arranged axially symmetrically with regard to the main axis and can thus be used in pairs for fixation of the construction element to the mounting element in a specific rotational position about the main axis. For this purpose, the fixation holes can be provided with internal threads for the engagement of fixation screws. Such a plurality of annular fixation holes with internal threads, which may be arranged axially symmetrically with regard to the main axis, may also be an advantage with other designs of the mounting element. Depending on the diameter of the mounting element, a greater number than eight fixation holes may be provided in order to be able to fix the rail to the mounting element in more finely graduated rotational positions about the main axis and thus also to be able to set more finely graduated lengths of the supporting column and corresponding height positions of the mounting element relative to the base element. Thus, there may be at least 12 or even at least 16 fixation holes in the mounting element arranged in a ring around the main axis. On the other hand, with a rather small pitch of the outer and inner threads, less than 8 fixation holes may be sufficient. Even two pairs or just a single pair of fixation holes may be fine.

In order to realize an adjustability of the bearing apparatus in a horizontal direction transverse to a rail-shaped construction element, elongated holes aligned transversely to the rail-shaped construction element can be provided in the base element for the passage of fixation bolts supported at the supporting structure. This allows the bearing apparatus to be aligned in the transverse direction relative to the supporting structure and then fixed to the supporting structure. In many cases, however, it is not necessary for the bearing apparatus to be specially adjustable in the direction of a rail-shaped construction element. Rather, a rail-shaped construction element can often be easily attached to the mounting element in the appropriate relative position in its longitudinal direction. However, if the construction element is attached to the mounting element via fixation holes in the construction element, these fixation holes can be designed as elongated holes elongated in the longitudinal direction.

If the bearing apparatus has at least one height compensation plate for arrangement between the base element and the supporting structure, the height compensation plate having holes for the passage of the fixation bolts supported at the supporting structure, the height compensation plates can be used to roughly adjust the height of the mounting element relative to the supporting structure so that only a smaller height difference between the mounting element and the base element needs to be compensated for with the aid of the screwed-in supporting column. In this way, the components of the supporting column can be held in mutual engagement over a large proportion of their lengths along the main axis.

In the bearing apparatus according to the present disclosure, the mounting element is may be supported at the base element exclusively via the mechanical series connection of the articulated joint arrangement and the supporting column. This is to be understood as meaning that there may be exactly one mechanical series connection consisting of exactly one articulated joint arrangement and exactly one supporting column between the base element and the mounting element, to which neither another such series connection nor any other supporting element is connected in parallel in the area of the respective bearing apparatus.

If the one of the inner column and the outer column that is formed integrally with the hollow joint head has radially oriented threaded bores above the rear side of the hollow joint head-like, for example, three threaded bores uniformly distributed in the circumferential direction around the main axis-into which screws are screwed or can be screwed for radial abutment against the other end of the clamping element, then, with the fastening bolt released, a pivot angle of the articulated joint arrangement can be limited or definedly adjusted by means of the screw-in positions of the screws.

As already indicated, the mounting element of the bearing apparatus can be designed for directly mounting a running rail. The mounting element can also be designed for mounting an intermediate rail, which in turn is designed for mounting a running rail. The additional intermediate rail can be particularly useful for high vertical loads in order to prevent the running rail from bending under these high loads.

A craneway according to the present disclosure has two rails and a plurality of bearing apparatuses according to the present disclosure serving as rail bearings. The bearing apparatuses are distributed along the two rails and orient the two rails in a defined manner with respect to a supporting structure. The supporting structure can be any sufficiently load-resistant structure made of, for example, concrete or steel beams, but can also be a number of support points formed on any sufficiently load-resistant substrate.

A steel building according to the present disclosure has a steel construction and a plurality of bearing apparatuses according to the present disclosure serving as building bearings. The bearing apparatuses are distributed over a structure interface of the steel construction and orient the steel construction in a defined manner with respect to a supporting structure. The structure interface can be an underside of the entire steel construction or, as in the case of a suspended platform, for example, an underside of a supporting frame of the steel construction. The supporting structure can be made of concrete, e.g. as a concrete foundation, but can also be made of other materials, such as wood or steel.

Even with an outer diameter of the supporting column of less than 30 cm, wall thicknesses of the outer column and the inner column of 10 mm each and intermeshing threads of the outer column and the inner column with an axial pitch of 2 mm and a radial depth of 1 mm, a load-bearing capacity of the bearing apparatus according to the present disclosure of more than 150,000 kg can be realized when using a commercially available structural steel S235.

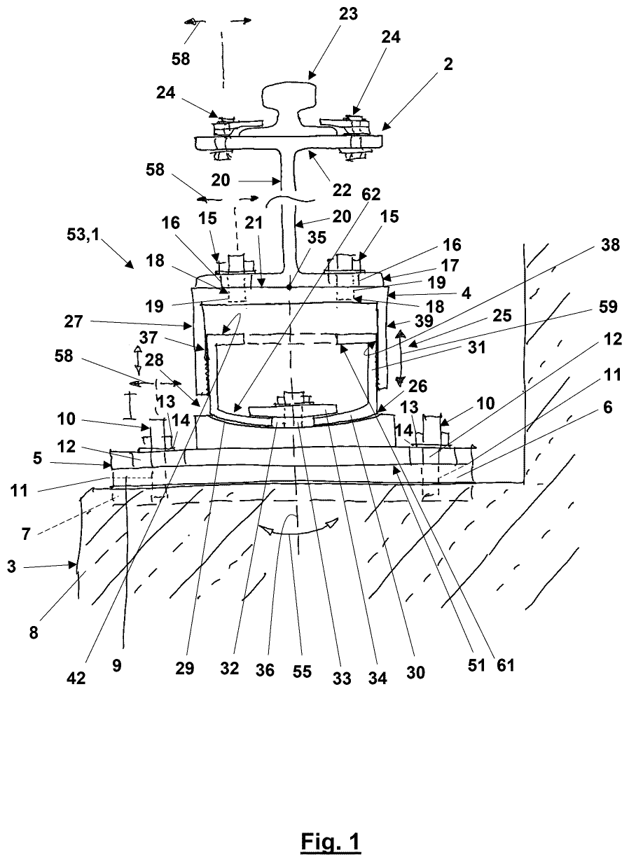

Now referring in greater detail to the drawings, the rail bearing 1 which is shown in the sectional view according to FIG. 1 as an example of a bearing apparatus according to the present disclosure serves to support and orient a rail 2 on and relative to a supporting structure 3. The rail 2 is an example of a construction element of a steel construction that can be supported at the supporting structure by means of the bearing apparatus. The rail bearing 1 has a mounting element 4 for mounting the rail 2 and a base element 5 for attachment to the supporting structure 3. The base element 5 rests here on a console 6 of the supporting structure 3, specifically on a fixation plate 7, which is embedded in a concrete body 8 of the supporting structure 3 and bonded to the concrete body 8. A height compensation plate 9 rests on the fixation plate 7, on which the base element 5 in turn rests. Fixation bolts 10 projecting from the fixation plate 7 extend through holes 11 in the height compensation plate 9 and through elongated holes 12 in the base element 5, which are elongated in the transverse direction to the rail 2. Nuts 13 screwed onto the fixation bolts 10 rest against the base element from above via washers 14 and clamp it against the fixation plate 7. This means that the base element 5 is fixed with respect to the fixation plate 7 in a position that is variable over the transverse extension of the elongated holes 12 and is predetermined by the thickness of the height compensation plate 9.

The rail 2 is screwed to the mounting element 4 with the aid of fixation screws 15. The fixation screws 15 engage through elongated holes 16 in a rail foot 17 of an intermediate rail 20 of the rail 2, which are elongated in the longitudinal direction of the rail 2, into fixation holes 18 in the mounting element 4. The fixation holes 18 are provided with internal threads 19. The rail foot 17 of the intermediate rail 20 rests directly or with an intermediate layer, not shown here, on a construction connection face 21 of the mounting element 4. A running rail 23 is attached with screwed clamps 24 to a rail head 22 of the intermediate rail 20, which is designed as a double T-beam.

The rail bearing 1 has a compensation device 25 between the mounting element 4 and the base element 5. The compensation device 25 comprises a mechanical series connection of an articulated joint arrangement 26 and a supporting column 27. The articulated joint arrangement 26 has a ball joint 28 with a joint housing 29 in the shape of a spherical shell section and a hollow joint head 30 also in the shape of a spherical shell section. The hollow joint head 30 is in full-surface contact with the joint housing 29. The hollow joint head 30 is a bottom region 54 of an pot-shaped inner column 31 of the supporting column 27. The hollow joint head 30 has an opening 32 through which a fastening bolt 33 engages in an internal thread, not shown, in the joint housing 29. The fastening bolt 33 has radial play in the opening 32. When the fastening bolt 33 is tightened, it presses a fastening element 34 with an underside in the shape of a spherical shell section, which rests on the edge of the opening 32, against the rear side 62 of the hollow joint head 30. In this way, the hollow joint head 30 and the joint housing 29 of the ball joint 28 are interlocked, and in this way the ball joint 26 is locked.

When the articulated joint arrangement 26 is not locked, the ball joint 28 allows the supporting column 27 to pivot relative to the base element 5 about any pivot axes that extend through a pivot point 35. The pivot point 35 is located along a vertically aligned main axis 36 of the rail bearing 1 in the area of the design connection face 21. The exact position of the pivot point 35 relative to the construction connection face 21 depends on the current length of the variable-length supporting column 27. In an embodiment, the pivot point 35 will never be further away from the construction connection face 21 than 20% of a height of the rail bearing 1 between a structure connection face 51 of the base element 5 and the construction connection face 21 of the mounting element 4 for any length of the supporting column 27. The ball bearing 28 of the unlocked articulated joint arrangement 26 allows the mounting element 4 to pivot with the construction connection face 21 about any pivot axis extending at a right angle to the main axis 36 through the pivot point 35. In addition, the ball joint 28 of the unlocked articulated joint arrangement 26 allows the mounting element 4 to be rotated relative to the base element 5 about the main axis 36. However, this is less relevant because the supporting column 27 can be screwed in to change its length.

Specifically, the inner column 31 of the supporting column 27 is provided on its outer circumference with an external thread 37, which engages over a plurality of thread turns in an internal thread 38 of an outer column 39, which is also pot-shaped. By relative rotation of the inner column 31 and the outer column 39 about the main axis 36, i.e. by screwing the inner column 31 into the outer column 39 to different extents, the length of the supporting column 27 between the articulated joint arrangement 26 and the mounting element 4 can be adjusted. In a same way as the hollow joint head 30 is formed by a bottom region 54 of the inner column 31 extending transversely to the main axis 36, the mounting element 4 is formed by a bottom region 43 of the outer column 39 extending transversely to the main axis 36.

The supporting column 27 has only a small elongation along the main axis 36. Its smallest outer diameter, i.e. the outer diameter of the inner column 31, is at least approximately as large as or even larger than the maximum length of the supporting column 27 along the main axis 36. This results not only in a high buckling stability of the supporting column 27, but, with a suitable choice of the profile of the threads 37 and 38, it also results in sufficiently large supporting surfaces between the inner column 31 and the outer column 39 in order to safely transfer forces acting on the rail bearing 1 in the direction of the main axis 36.

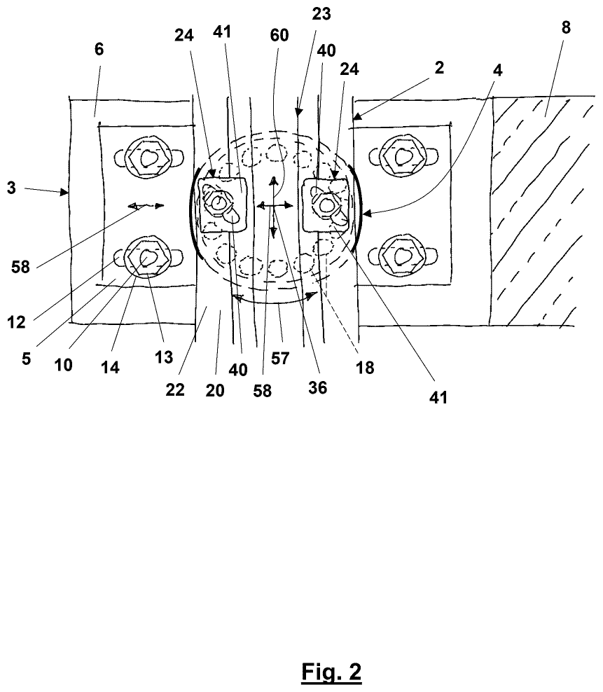

The screwed-in position of the supporting column 27 and thus its length is fixed by the rail 2 attached to the mounting element 4 when the articulated joint arrangement 26 is locked. In order to be able to attach the rail 2 to the mounting element 4 in almost any rotational position of the outer column 39 relative to the inner column 31, a larger number of fixation holes 18 with internal threads are provided in the mounting element 4 which is essentially concealed in FIG. 2, the fixation holes 18 being arranged in a ring around the main axis 36 and axially symmetrical to the main axis 36. Here, a total of 16 fixation holes 18 with internal threads are arranged in the mounting element 4 at equal distances 16 around the main axis 36.

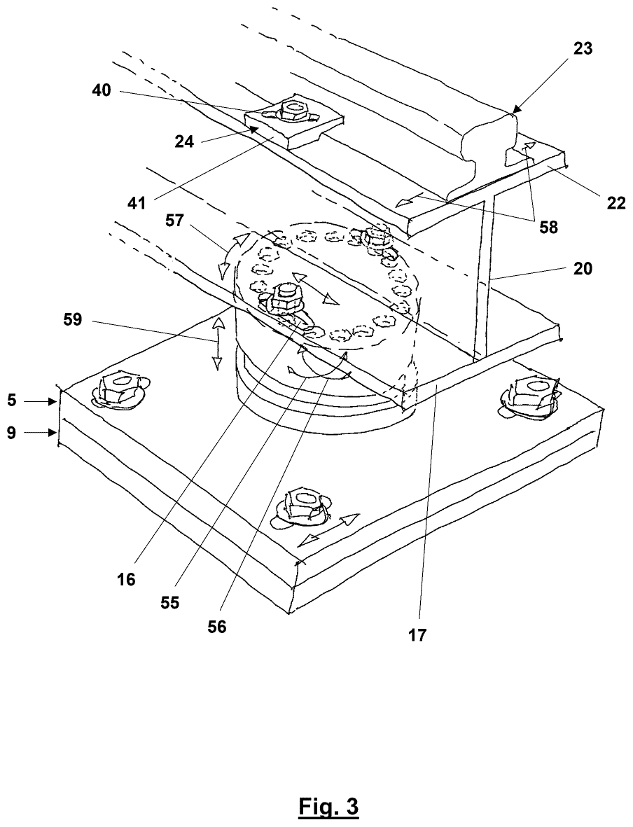

The perspective view according to FIG. 3 shows even more clearly than FIG. 2 that the screwed clamps 24 allow the running rail 23 to be adjusted in the horizontal transverse direction relative to the intermediate rail 20 with the aid of elongated holes 40 in their clamping elements 41. The design of the elongated holes 16 in the base 17 of the intermediate rail 20 can also be seen more clearly in FIG. 3 than in FIGS. 1 and 2.

When mounting the rail bearing 1, an upper side 42 of the inner column 31 can first be oriented horizontally using the articulated joint arrangement 26. The articulated joint arrangement 26 is then locked by tightening the fastening bolt 33 before the outer column 39 is screwed onto the inner column 31. Screwing-in is carried out until the construction connection face 21, which runs parallel to the upper side 42, is at a desired height above the supporting structure 3. The rail 2 is then attached to the mounting element 4 to fix this height position. The lateral alignment of the rail bearing 1 transverse to the supporting structure 3 can also be brought about later and is then fixed by tightening the nuts 13 on the fixation bolts 20.

The double arrows 55 to 60 in the figures described so far and in the following figures indicate the adjustment options available for the rail bearing 1. They relate to all three rotational degrees of freedom, see double arrows 55 to 57, and all three translational degrees of freedom, see double arrows 58 to 60.

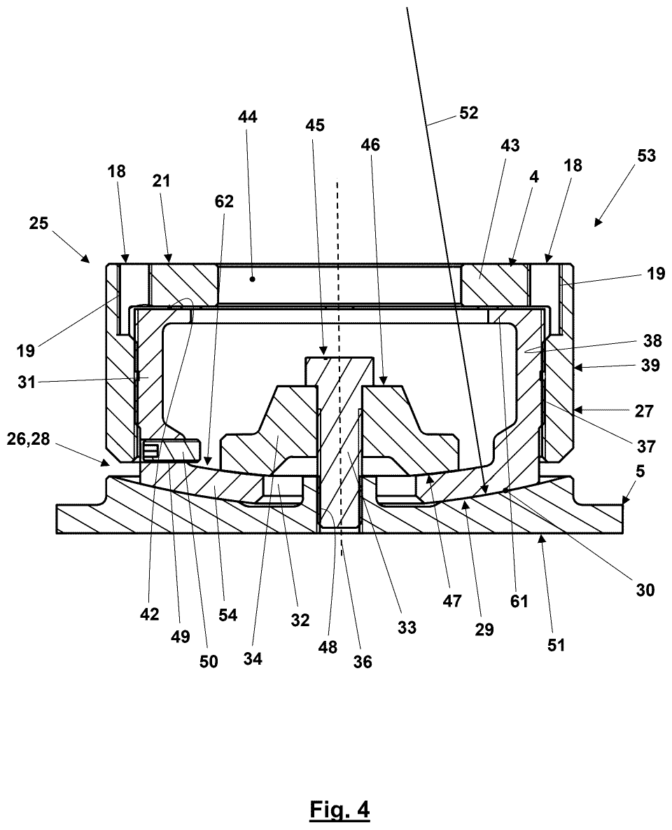

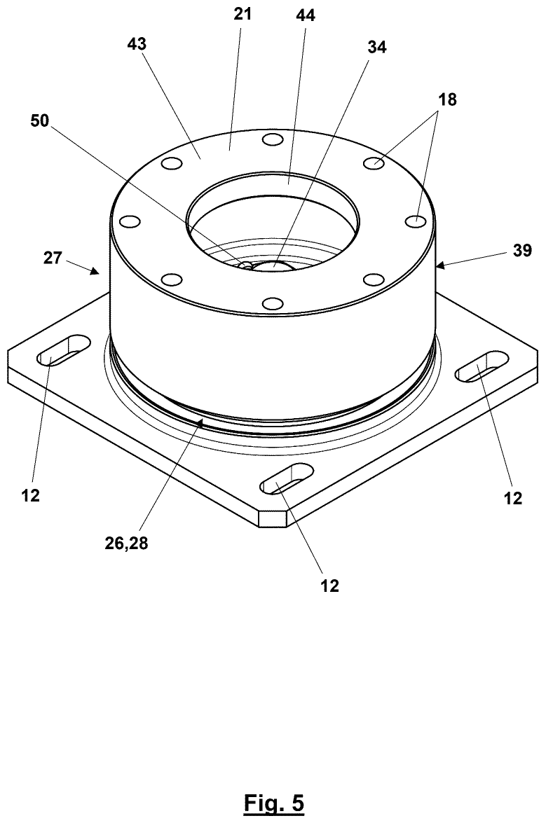

The bearing apparatus 53 according to FIG. 4 and FIG. 5 differs from the components of the bearing apparatus 53 according to FIGS. 1 to 3 in the region between the structure connection face 51 and the steel construction connection face 21 by the following features.

The bottom region 43 of the outer column 39, which forms the mounting element 4 with the construction connection face 21, has a central opening 44. The central opening 44 is dimensioned such that, at least as long as no rail 2 or intermediate rail 20 according to FIG. 1 is supported on the mounting element 4, it provides access to the fastening bolt 33 to tighten it, for example, by means of a socket wrench.

As a result, the bearing apparatus 53 does not have to be assembled and possibly disassembled on site to adjust the articulated joint arrangement 26. Rather, it can be adjusted in the assembled state both with respect to the height position and the angular position of the mounting element 4 relative to the base element 5.

FIG. 4 shows that the fastening bolt 33 engages in an internal thread 48 in the base element 5 forming the joint housing 29 and bears with its head 45 against an upper end 46 of the fastening element 34, which is formed here in a bell- or funnel-shaped manner. The spherical-segment-shaped underside 47 of the fastening element 34 bears against the likewise spherical-segment-shaped rear side 62 of the hollow joint head 30. The fastening element 34 has at its underside 47 an outer diameter approximately twice as large as that at its upper end 46. An inner diameter of the fastening element 34 at its lower end or the spherical-segment-shaped underside 47 is about three times as large as the inner diameter of the fastening element 34 at its upper end. A half cone angle of a virtual cone connecting the abutment of the head 45 at the upper end 46 with the spherical-segment-shaped underside 47 is about 40°. This enables the clamping force exerted by the head 45 on the upper end 46 to be efficiently transmitted to the spherical-segment-shaped underside 47.

Furthermore, the fastening element 34 has a certain height along the fastening bolt 33, so that the fastening bolt 33 extends above the internal thread, which allows a certain elongation and thus the application of a high elastic prestress in the fastening bolt 33. In addition, the head 45 is thereby raised within the inner column 31 to such an extent that it can easily be accessed through the opening 44 with a tool.

In addition, threaded bores 49 are provided in the inner column 31 above the rear side 62 of the hollow joint head 30, oriented radially relative to the main axis 36. Specifically, three threaded bores 49 are uniformly distributed around the main axis 36. Screws 50 are screwed into the threaded bores 49 and form movable stops for the fastening element 34. By changing the screwing depth of the screws 50 into the threaded bores 49, the hollow joint head 30 can be displaced or pivoted in a defined manner relative to the joint housing 29. The radius 52 of the resulting pivoting motion is indicated in FIG. 4. This radius is approximately twice as large as the outer circumference of the inner column 31, that is the diameter of the external thread 37 and the internal thread 38. Accordingly, the pivot point 35 of the ball joint 28 lies slightly more than the height of the bearing apparatus 53 according to FIG. 4 above the construction connection face 21.

As already shown in FIGS. 1 to 3, the inner column 31 has at its upper end, with the upper side 42, an inwardly directed reinforcing flange 61 for increasing its shape stability.

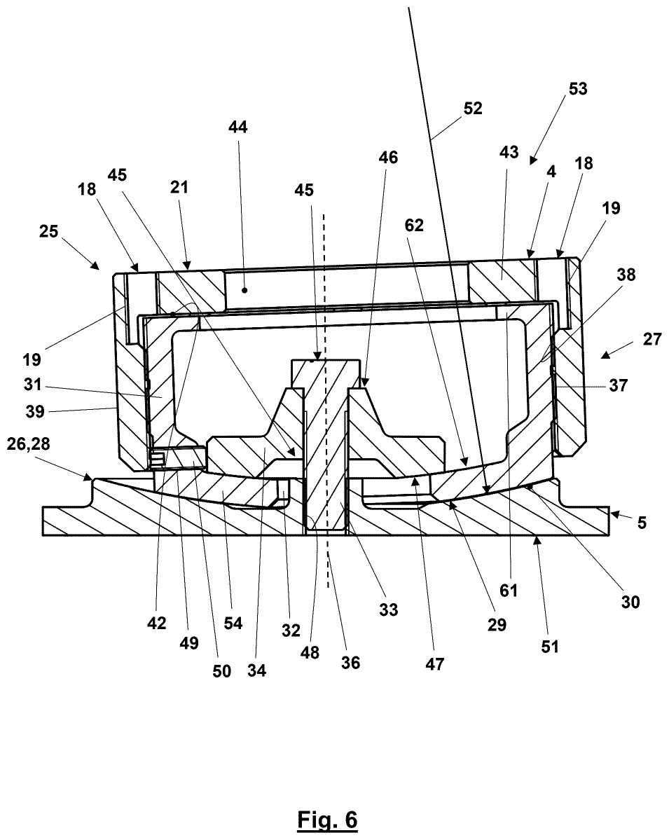

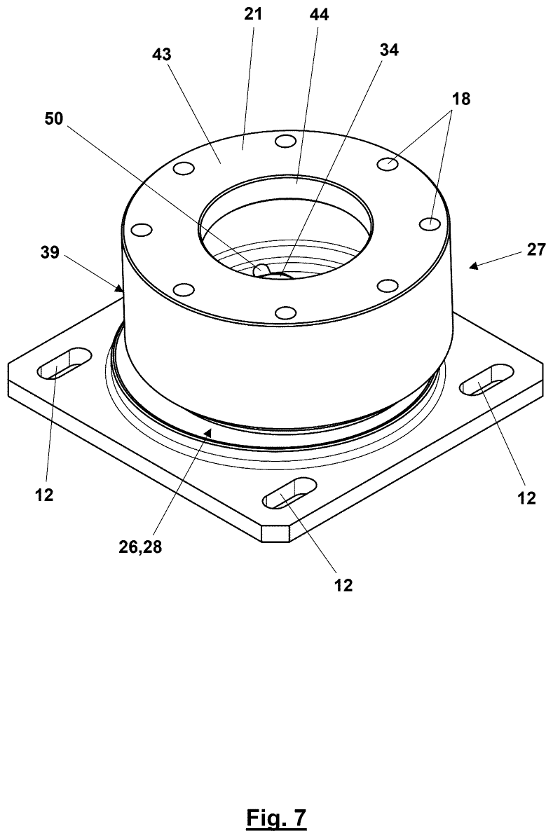

FIG. 6 and FIG. 7 show the bearing apparatus 53 according to FIGS. 4 and 5 with the construction connection face 21 inclined downward to the left relative to the structure connection face 51 in FIG. 6. The engagement of the screw 50 visible in the sectional view of FIG. 6 against the outer circumference of the fastening element 34 directly above its spherical-segment-shaped underside 47 can be seen. This engagement can be used to precisely define the angular position of the mounting element 4 relative to the base element 5 via the screw-in position of the screw 50. The angle between the construction connection face 21 and the structure connection face 51 shown in FIGS. 6 and 7 is 2°.

Many variations and modifications may be made to the preferred embodiments of the invention without departing substantially from the spirit and principles of the invention. All such modifications and variations are intended to be included herein within the scope of the present invention, as defined by the following claims.

We claim:

1. A bearing apparatus, comprising
a virtual main axis to be aligned vertically,
a mounting element configured for mounting a construction element of a steel construction,
a base element configured for being attached to a supporting structure, and
an adjustable compensation device extending between the mounting element and the base element along the virtual main axis and configured for orienting the mounting element with respect to the base element and for supporting the mounting element at the base element in direction of the virtual main axis,
wherein the compensation device comprises a mechanical series connection of
an articulated joint arrangement which defines a pivot point located on the main axis and which can be locked and unlocked, and
a supporting column comprising an inner column and an outer column and a length along the virtual main axis which can be varied by screwing the inner column in the outer column,
the mechanical series connection extending along the main axis,
wherein the unlocked articulated joint arrangement allows the mounting element to pivot relative to the base element about any pivot axis which intersects the main axis at a right angle at the pivot point, and
wherein a screwed-in position of the inner column in the outer column of the supporting column is fixed by a construction element mounted to the mounting element,
such that a height position and an angular position of the mounting element relative to the base element can be adjusted with the aid of the compensation device.

2. The bearing apparatus of claim 1, wherein the articulated joint arrangement has a ball joint comprising a joint housing in the shape of a spherical shell section and a hollow joint head resting therein.

3. The bearing apparatus of claim 2, wherein a head diameter of the hollow joint head extending transversely to the virtual main axis is not smaller than a smallest column diameter of the supporting column extending transversely to the virtual main axis.

4. The bearing apparatus of claim 2, wherein the hollow joint head has an opening for a passage of a fastening bolt extending along the virtual main axis, wherein the fastening bolt has radial play in the opening and presses a clamping element having a spherical-segment-shaped underside, which rests on the edge of the opening, against a rear side of the hollow joint head.

5. The bearing apparatus of claim 4, wherein the fastening bolt bears against the fastening element at its one end having a small inner diameter and a small outer diameter, wherein the spherical-segment-shaped underside at the other of the fastening element has a large inner diameter and a large outer diameter, wherein the large inner diameter is at least twice as large as the small inner diameter and the large outer diameter is at least 1.5 times as large as the small outer diameter.

6. The bearing apparatus of claim 5, wherein the large inner diameter is 2.5 to 5 times as large as the small inner diameter, and the large outer diameter is 1.75 to 3 times as large as the small outer diameter.

7. The bearing apparatus of claim 5, wherein one of the inner column and the outer column is integral with the hollow joint head of the ball joint and has, above the rear side of the hollow joint head, radially oriented threaded bores distributed in the circumferential direction around the main axis, into which screws are screwed for radial abutment against the other end of the fastening element.

8. The bearing apparatus of claim 1, wherein a smallest column diameter of the supporting column transverse to the main axis is at least 100% of a maximum column height of the supporting column along the main axis.

9. The bearing apparatus of claim 1, wherein the outer column is pot-shaped column and has an internal thread, and wherein the inner column has an external thread screwed into the internal thread, and wherein the external thread engages in the internal thread over at least 5 thread turns in each length of the supporting column.

10. The bearing apparatus of claim 8, wherein the external thread has at least one of
a diameter in a range from 100 mm to 200 mm or
a pitch in a range from 1% to 4% of the diameter.

11. The bearing apparatus of claim 1, wherein one of the outer column or the inner column is integral with a component of the articulated joint arrangement.

12. The bearing apparatus of claim 1, wherein a bottom region of the inner column or of the outer column, which extends transversely to the virtual main axis, is provided with fixation holes distributed annularly around the main axis.

13. The bearing apparatus of claim 12, wherein the fixation holes are arranged axially symmetrically with respect to the main axis, and wherein the fixation holes are provided with internal threads for the engagement of fixation screws.

14. The bearing apparatus of claim 12, wherein the bottom region extending transversely to the main axis is the bottom region of the outer column, and wherein the inner column has, at its end opposite the hollow joint head, an inwardly directed reinforcing flange.

15. The bearing apparatus of claim 12, wherein the bottom region has a central opening for a passage of a tool for locking the articulated joint arrangement.

16. The bearing apparatus of claim 1, wherein the base element has elongated holes for a passage of fixation bolts supported at the supporting structure, wherein the elongated holes are aligned transversely to a horizontal main direction of extension of the construction element.

17. The bearing apparatus of claim 16, wherein at least one height compensating plate is provided for arrangement between the base element and the supporting structure, wherein the height compensating plate has holes for a passage of the fixation bolts supported at the supporting structure.

18. A rail bearing comprising
a virtual main axis to be aligned vertically,
a mounting element configured for mounting a rail,
a base element configured for being attached to a supporting structure, and
an adjustable compensation device extending between the mounting element and the base element along the virtual main axis and configured for orienting the mounting element with respect to the base element and for supporting the mounting element at the base element in direction of the virtual main axis,
wherein the compensation device comprises a mechanical series connection of
an articulated joint arrangement which defines a pivot point located on the main axis and which can be locked and unlocked, and
a supporting column comprising an inner column and an outer column and a length along the virtual main axis which can be varied by screwing the inner column in the outer column,
the mechanical series connection extending along the main axis,
wherein the unlocked articulated joint arrangement allows the mounting element to pivot relative to the base element about any pivot axis which intersects the main axis at a right angle at the pivot point,
wherein a screwed-in position of the inner column in the outer column of the supporting column is fixed by a rail mounted to the mounting element,
wherein a smallest column diameter of the supporting column transverse to the main axis is at least about 100% of a maximum column height of the supporting column along the main axis,
wherein the outer column is pot-shaped column and has an internal thread, and wherein the inner column has an external thread screwed into the internal thread,
wherein the external thread engages in the internal thread over at least 3 thread turns in each length of the supporting column, and
wherein the mounting element is supported at the base element exclusively via the mechanical series connection of the articulated joint arrangement and the supporting column.

19. The rail bearing of claim 18, wherein the articulated joint arrangement has a ball joint comprising a joint housing in the shape of a spherical shell section and a hollow joint head resting therein, wherein the base element is integral with the joint housing and the inner column is integral with the hollow joint head of the ball joint,
wherein the hollow joint head has an opening for a passage of a fastening bolt extending along the virtual main axis, wherein the fastening bolt has radial play in the opening and presses a clamping element having a spherical-segment-shaped underside, which rests on the edge of the opening, against a rear side of the hollow joint head,
wherein a bottom region of the outer column, which extends transversely to the virtual main axis, has fixation holes distributed annularly around the main axis and a central opening for a passage of a tool for tightening the fastening bolt, and
wherein the inner column has, at its end opposite the hollow joint head, an inwardly directed reinforcing flange.

20. The rail bearing of claim 18, wherein the mounting element is configured for mounting a rail of a craneway.
